(19) United States
(12) Patent Application Publication
(10) Pub. No.: US 2026/0254235 A1
(43) Pub. Date: Aug. 27, 2026

(54) VARIABLE-SPEED DC GENERATOR

(71) Applicant: SHIP AND OCEAN INDUSTRIES R&D CENTER, New Taipei City (TW)

(72) Inventors: TA-HSIU TSENG, New Taipei City (TW); YU-LIN DING, New Taipei City (TW); HAN-CHUN KAO, New Taipei City (TW)

(21) Appl. No.: 19/215,256

(22) Filed: May 21, 2025

(30) Foreign Application Priority Data
Feb. 27, 2025 (TW) 114107271

(51) Int. Cl. H02J 1/14; H02P 9/02; H02P 101/25; H02P 101/35

(52) U.S. Cl. CPC H02J 1/14; H02P 9/02; H02J 2105/31; H02P 2101/25; H02P 2101/35

(57) ABSTRACT

The present invention discloses a variable-speed DC generator which is connected to a DC grid. The variable-speed DC generator comprises a controller, a power source, a permanent magnet generator and an electronic power converter. The controller receives a total demand power of load(s) from the DC grid. The power source is connected to the controller, and the power source is operated under a rotational speed. The permanent magnet generator is connected to the power source, and the electronic power converter is connected to the permanent magnet generator and the controller. The controller senses an output power which is output by the electronic power converter to the DC grid, and compares whether the output power meets the total demand power of the loads, thereby adjusting the rotational speed of the power source.

### TECHNICAL FIELD

The present invention relates to a variable-speed direct current (DC) generator, especially for a controller receiving an output power which is output by the electronic power converter to the DC grid compares whether the output power meets the total demand power of loads, thereby adjusting the rotational speed of the power source.

### BACKGROUND OF RELATED ARTS

Frequency conversion technology has been widely used in power system of motor vehicle propulsion due to development of frequency conversion technology in recent years. Generally speaking, the drive device of this type of variable frequency motor needs to convert the input alternating current (AC) power into DC power through the internal circuit, and then output power of different frequencies to the motor through pulse-width modulation (PWM), so as to change the output speed or output torque of the motor to meet the needs of users.

In this background, drive device which directly uses DC power began to appear on the market to improve the overall power conversion efficiency, and thus the DC grid structure was created. To achieve a balance between power supply and power consumption in the DC grid, an energy storage system or a constant speed AC generator with a rectifier is usually used as a DC power supply source therein.

Vehicle with constant speed AC generator usually has a considerable number of household electrical load(s). However, the electrical load(s) does not be operated under high load conditions all the time. If the internal combustion engine is operated under low load conditions for a long time and the constant speed AC generator is used as the power source for these household electric load(s), it will cause problems such as low fuel efficiency and carbon deposit on the cylinder wall of the internal combustion engine, thereby increasing consumption and the need for maintenance.

### SUMMARY

Therefore, the present invention is to provide a variable-speed DC generator, the variable-speed DC generator connects to a DC grid. The variable-speed DC generator includes a controller, a power source, a permanent magnet generator and an electronic power converter.

The controller receives a total demand power of load from the DC grid. The power source connects to the controller, and the power source is operated under a rotational speed. The permanent magnet generator connects to the power source. The electronic power converter connects to the permanent magnet generator and the controller.

The controller senses an output power which is output by the electronic power convert to the DC grid. The controller compares whether the output power meets the total demand power of loads, thereby adjusting the rotational speed of the power source.

Embodiments of the invention are illustrated by way of example, and not by way of limitation, in the figures of the accompanying drawings in which like reference numerals refer to similar elements.

### BRIEF DESCRIPTION OF THE DRAWINGS

FIG. 1 shows a framework diagram of the variable-speed DC generator of an embodiment of the present invention.

FIG. 2 shows a framework diagram of the variable-speed DC generator of another embodiment of the present invention.

FIG. 3 shows a framework diagram of the variable-speed DC generator of the other embodiment of the present invention.

### DETAILED DESCRIPTION OF THE INVENTION

In order to understand the technical features and practical efficacy of the present invention and to implement the technical features and practical efficacy in accordance with the contents of the specification, hereinafter, preferred embodiments of the present invention will be described in detail with reference to the accompanying drawings.

First, the “connection” mentioned in this embodiment does not actually have absolute limitation in space and location. Specifically, the term “connection” should reasonably be understood as any physical connection that can realize the function. The physical connection includes mechanical connection, electrical connection, wired connection or wireless connection, and the invention is not limited to these.

In addition, the spatial position mentioned in the present embodiment should be understood as not constituting limitation to the present invention as long as the connection relationship between the various components is not changed.

### Embodiment 1

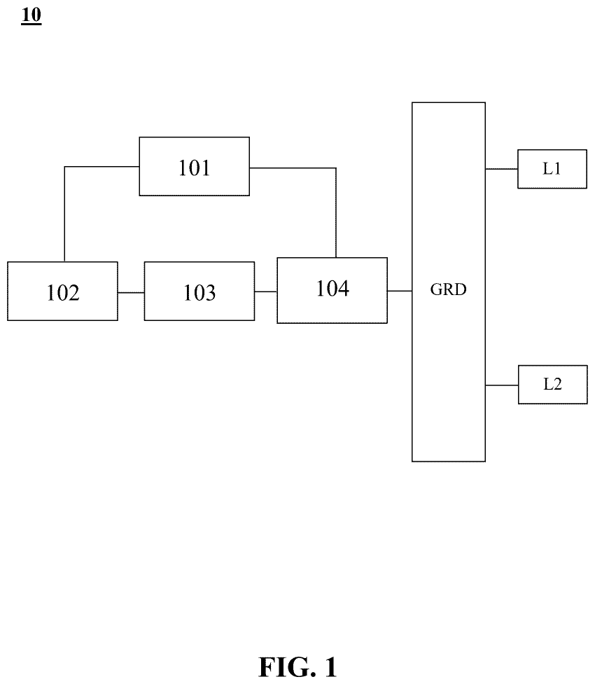

First, please refer to FIG. 1, FIG. 1 is a framework diagram of the variable-speed direct current (DC) generator of an embodiment of the present invention. In the embodiment of FIG. 1, the variable-speed DC generator 10 mainly includes controller 101, power source 102, permanent magnet generator 103 and electronic power converter 104.

The controller 101 receives a total demand power of load from the DC grid GRD. Specifically, the total demand power of load of DC grid GRD may be measured by a power sensor of the DC grid GRD itself, and informs the controller 101 in any possible way, and the present invention is not limited thereto.

Furthermore, the total demand power of load of the present embodiment is also related the load which is connected to the DC grid GRD. In the present embodiment, the DC grid GRD provides the load L1 and the load L2 for operation. Therefore, the operation demand of the load L1 and the load L2 will affect the total demand power of load of the DC grid GRD.

In the present embodiment, the controller 101 is Single-chip microcomputer, Microcontroller Unit (MCU), Micro Processing Unit (MPU) or Programmable Logic Controller (PLC) or the component with calculating and control capability. More specifically, the control capability of the controller 101 may be an electronic control capability of outputting digital signal or analog signal.

In the present embodiment, the power source 102 connects to the controller 101, and the power source 102 is operated under a rotational speed which is commanded by the controller 101. Specifically, the controller 101 of the present embodiment can adjust the rotational speed of the power source 102, and the power source 102 can be an engine which is an electronically controlled engine in the present embodiment. Therefore, the controller 101 can change the rotational speed of the power source 102 through digital signal or analog signal.

Furthermore, the permanent magnet generator 103 of the present embodiment connects to the power source 102, and the electronic power converter 104 connects to the permanent magnet generator 103 and the controller 101. The controller 101 changes the rotational speed of the power source 102, and the controller 101 of the present embodiment can also adjust the parameters such as voltage, power and/or the combination therefore which are output by the electronic power converter 104 to the DC grid GRD for matching the power demand conditions of the load L1, the load L2 and/or the combination therefore of the DC grid GRD.

In summary, the controller 101 of the present embodiment senses the output power of the electronic power converter 104 output to the DC grid, and compares whether the output power of the electronic power converter 104 meets the total demand power of load of the load L1 and the load L2, and to change the rotational speed of the power source 102, therefore to apply energy with maximum efficiency.

### Embodiment 2

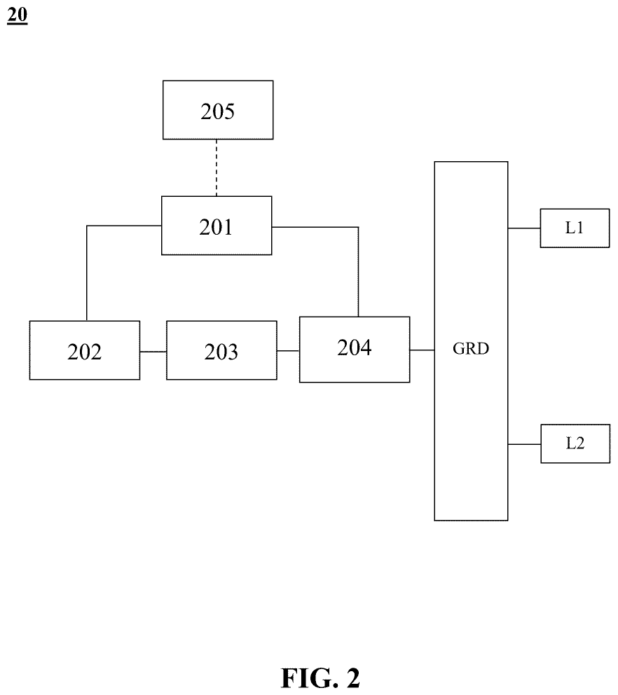

Please refer to FIG. 2, FIG. 2 is a framework diagram of the variable-speed DC generator of another embodiment of the present invention. In the embodiment of FIG. 2, variable-speed DC generator 20 mainly includes controller 201, power source 202, permanent magnet generator 203, electronic power converter 204 and input device 205.

The controller 201 receives the total demand power of load from the DC grid GRD. Specifically, the total demand power of load of the DC grid GRD may be measured by the power sensor of the DC grid GRD itself. The total demand power of load is output to the input device 205 through a wired network, wireless network or a wireless communication method such as WiFi™, Bluetooth™, etc., and the total demand power of load of the DC grid GRD is then notified to the controller 201 through the input device 205.

Further, the total demand power of load of the present embodiment is also related to the load which connects to the DC grid GRD. In the present embodiment, the DC grid GRD provides the load L1 and the load L2 for operation. Therefore, the operation demand of the load L1 and the load L2 will affect the total demand power of load of the DC grid GRD.

In the present embodiment, the controller 201 is Single-chip microcomputer, Microcontroller Unit (MCU), Micro Processing Unit (MPU) or Programmable Logic Controller (PLC) or the component with calculating and control capability. More specifically, the control capability of the controller 201 may be an electronic control capability of outputting digital signal or analog signal.

In the present embodiment, the power source 202 connects to the controller 201, and the power source 202 is operated under a rotational speed which is commanded by the controller 201. Specifically, the controller 201 of the present embodiment may adjust the rotational speed of the power source 202. Therefore, the power source 202 may be an engine which is an electronically controlled engine in the present embodiment, and then let the controller 201 change the rotational speed of the power source 202 through digital signal or analog signal.

In the present embodiment, the controller 201 may adjust the power source 202 according to the total demand power of load of the DC grid GRD, and the controller 201 may also directly receive parameters from the input device 205 for control. The at least one input device 205 is cell phone, computer and/or the combination thereof. Of course, in the possible implementing embodiment, the input device 205 may include any control machine of human-machine interface or panel of human-machine interface. The present invention is not limited thereto.

Further, the permanent magnet generator 203 which is illustrated in the present embodiment connects to the power source 202, and the electronic power converter 204 connects to the permanent magnet generator 203 and the controller 201. The controller 201 of the present embodiment changes the rotational speed of the power source 202, and may further adjust the parameters which are output from the electronic power converter 204 output to the DC grid GRD such as voltage, power and/or the combination thereof, therefore to match the total demand power of load of the load L1, the load L2 and/or the combination thereof in the DC grid GRD.

In summary, the controller 201 of the present embodiment senses output power which is output by the electronic power convert 204 to the DC grid, and compares whether the output power of the electronic power converter 204 meets the total demand power of load of the load L1 and the load L2 to change the rotational speed of the power source 202, therefore to apply energy with efficiency.

Considering to the input device 205 is contained in the present embodiment, the control capability of the controller 201 may be directly changed by the user inserted command to the input device 205. Hence, the user can arbitrarily change the parameters which are output from the electronic power converter 204 to the DC grid GRD such as the voltage, power and/or the combination thereof through the manual mode. The user can also manually change the speed of the power source 202. When the total demand power of load of the load L1 and the load L2 are much greater than the speed that the power source 202 can provide or the power that the electronic power converter 204 can output, the input device 205 can also receive the judgment command from the controller 201 and display the judgment command on the input device 205 such as touch screen or other display device. The input device 205 informs the user that current variable-speed DC generator 20 has reached the maximum output power but is still insufficient to provide the load L1 and the load L2 of the DC grid GRD, or otherwise informs the user that the power output by the DC generator 20 is lower than the demand power of starting the load L1 and the load L2, etc., and the present invention is not limited thereto.

### Embodiment 3

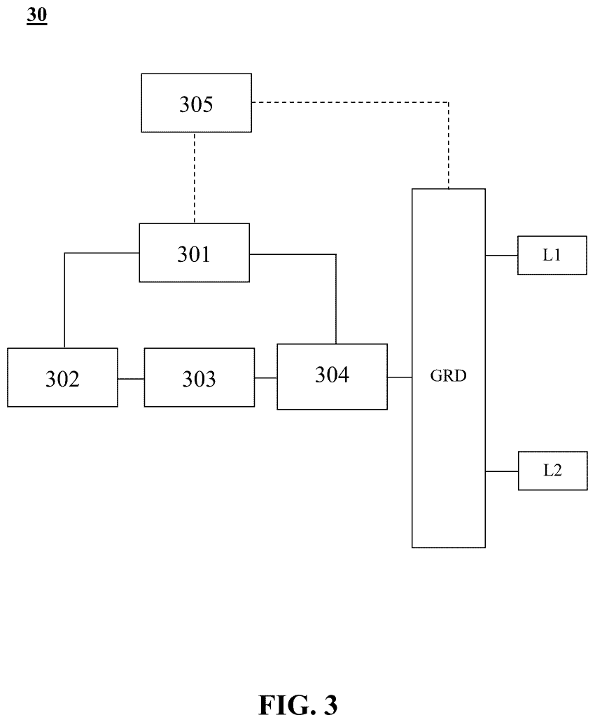

Please refer to FIG. 3, the FIG. 3 is a framework diagram of the variable-speed DC generator of the other embodiment of the present invention. In the present embodiment of FIG. 3, variable-speed DC generator 30 mainly includes controller 301, power source 302, permanent magnet generator 303, electronic power converter 304 and power sensing device 305.

The controller 301 receives the total demand power of load from the DC grid GRD. Specifically, the power sensing device 305 of the present embodiment is power meter or other power sensor that measures the total demand power of load of the DC grid GRD, and informs the controller 301 in real time after measuring the total demand power of load of the DC grid GRD.

Furthermore, the total demand power of load of the present embodiment is also related to the load which connects to the DC grid GRD. In the present embodiment, the DC grid GRD supplies power to the load L1 and the load L2 for operation. Therefore, the operation demand of the load L1 and the load L2 will affect the total demand power of load of the DC grid GRD.

In the present embodiment, the controller 301 is Single-chip microcomputer, Microcontroller Unit (MCU), Micro Processing Unit (MPU) or Programmable Logic Controller (PLC) or the component with calculating and control capability. More specifically, the control capability of the controller 301 may be electronic control capability of outputting digital signal or analog signal.

In the present embodiment, the power source 302 connects to the controller 301, and the power source 302 is operated under a rotational speed which is commanded by the controller 301. Specifically, the controller 301 of the present embodiment may adjust the rotational speed of the power source 302. The power source 302 can be an engine which is an electronically controlled engine in the present embodiment, thus the controller 301 can change the rotational speed of the power source 302 through digital signal or analog signal.

Furthermore, permanent magnet generator 303 of the present embodiment connects to the power source 302, and the electronic power converter 304 connects to the permanent magnet generator 303 and the controller 301. The controller 301 of the present embodiment changes the rotational speed of the power source 302, and may further adjust the parameters which are output from the electronic power converter 304 output to the DC grid GRD such as voltage, power and/or the combination thereof, therefore to match the total demand power of load of the load L1, the load L2 and/or the combination thereof in the DC grid GRD.

In summary, the controller 301 of the present embodiment senses output power which is output by the electronic power convert 304 to the DC grid GRD, and compares whether the output power of the electronic power converter 304 meets the total demand power of load of the load L1 and the load L2 to change the rotational speed of the power source 302, therefore to apply energy with efficiency.

It is particularly important to explain, the variable-speed DC generator 10, the variable-speed DC generator 20 and the variable-speed DC generator 30 which are respectively disclosed in the present embodiment 1, embodiment 2 or embodiment 3 can all be used in the power system of water surface vehicle such as ship and boat.

When the variable-speed DC generator 10, the variable-speed DC generator 20 and the variable-speed DC generator 30 are applied to the power system of the water surface vehicle, the DC grid GRD can be a DC bus or busbar of the water surface vehicle. The load L1 and the load L2 may be propulsion device of water surface vehicle, such as propellers. Of course, in a possible implementation, the load L1 and the load L2 may also be any mechanical boom driven by direct current or even a power-consuming payload on the water vehicle, such as a refrigerator, a microwave oven, etc. The present invention is not limited thereto.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure. While the preferred embodiment of the invention has been illustrated and described, it will be appreciated that various changes can be made therein without departing from the spirit and scope of the invention.

What is claimed is:

1. A variable-speed direct current (DC) generator, connecting to a DC grid, the variable-speed DC generator comprising:
a controller, received a total demand power of load from the DC grid;
a power source, connected to the controller, the power source is operated under a rotational speed;
a permanent magnet generator, connected to the power source; and
an electronic power converter, connected to the permanent magnet generator and the controller; wherein the controller senses an output power which is output by the electronic power convert to the DC grid;
wherein the controller compares whether the output power meets the total demand power of the loads, thereby adjusting the rotational speed of the power source.

2. The variable-speed DC generator as claimed in claim 1, wherein the controller is Single-chip microcomputer, Microcontroller Unit (MCU), Micro Processing Unit (MPU) or Programmable Logic Controller (PLC).

3. The variable-speed DC generator as claimed in claim 1, wherein the power source is an engine.

4. The variable-speed DC generator as claimed in claim 3, wherein the engine is electronic control engine.

5. The variable-speed DC generator as claimed in claim 4, wherein the controller changes the rotational speed of the electronic control engine via digital signal or analog signal.

6. The variable-speed DC generator as claimed in claim 1, wherein the controller further connects to at least one input device.

7. The variable-speed DC generator as claimed in claim 6, wherein the at least one input device is cell phone, computer and/or the combination thereof.

8. The variable-speed DC generator as claimed in claim 6, wherein the at least one input device includes a Human Machine Interface (HMI).

9. The variable-speed DC generator as claimed in claim 1, wherein the controller adjusts the electronic power converter outputting voltage, power and/or combinations thereof.

10. The variable-speed DC generator as claimed in claim 1, wherein the DC grid further connects to at least one load.
